(19) United States
(12) Patent Application Publication
(10) Pub. No.: US 2010/0214129 A1
(43) Pub. Date: Aug. 26, 2010

(54) DEVICE FOR THE LIGHTING AND/OR DEMARCATION OF PEDESTRIAN CROSSINGS

(75) Inventors: Jordi Brualla Marti, Barcelona (ES); Xavier Marti Charlo, Barcelona (ES); Jordi Sánchez Acosta, Barcelona (ES); Jordi Serrat Llorens, Girona (ES)

Correspondence Address: MERCHANT & GOULD PC, P.O. BOX 2903, MINNEAPOLIS, MN, 55402-0903, US

(73) Assignee: SMARTEN 2000 S.L., BARCELONA (ES)

(21) Appl. No.: 12/532,620

(22) PCT Filed: Mar. 19, 2008
(86) PCT No.: PCT/ES08/00156

§ 371 Date: Mar. 9, 2010

(30) Foreign Application Priority Data
Mar. 23, 2007 (ES) U 200700645
Feb. 25, 2008 (ES) U 200800375

(51) Int. Cl. G08G 1/095

(52) U.S. Cl. 340/944

(57) ABSTRACT

A device is for lighting and/or demarcation of pedestrian crossings. Normally pedestrian crossings are in many cases difficult to identify by users, because they are insufficiently lit or demarcated. Posts or columns are provided with lighting means formed by lighting advertising lamps which light and/or demarcate pedestrian crossings perfectly. The correct lighting of pedestrian crossings is achieved by lighting lamps placed mainly in the lower part of the posts or columns, with the effect that the light beams thereof spread out and light the surface of the pedestrian crossing. The demarcation of pedestrian crossings is achieved by positioning posts or advertising columns in at least one corner at each end of the pedestrian crossing.

### OBJECT OF THE INVENTION

The present invention refers to a device for the lighting and/or demarcation of pedestrian crossings comprising various posts for arrangement on the corners of pedestrian crossings and that provide optimal lighting, and a demarcation of pedestrian crossings, crosswalks, and specific crossings for bicycles, horses, and others.

### BACKGROUND TO THE INVENTION

There are pedestrian crossings and crosswalks that are not normally marked, and many times they are not properly indicated, they are practically erased or non-existent, and at times they correspond to raised traffic lights. At times the lines indicating the pedestrian crossing or crosswalk are practically erased by layers that have come to cover it during paving work, etc.

In all of these cases, it is difficult for pedestrians or users to locate the position of the pedestrian crossing, or the crosswalk or specific crossing for the place, in order to be able to cross the street safely.

There are also pedestrian crossings that correspond to the position of the traffic lights, allowing users to pass or making them wait.

But it often happens that the traffic lights don't work, or have been removed for repair, or for changes in the urban planning of the site in question, and there is no indication of the location of the pedestrian or similar crossing.

On the other hand, there are lighting devices for pedestrian crossings that are made up of one or more posts placed close to the pedestrian crossings and projecting light onto the street, in such a manner that they provide increased road safety for both pedestrians and automobiles.

These posts usually have lights and lamps arranged in such a manner that they project the light produced onto the ground, preferably onto the pedestrian crossing.

However, these posts rarely optimise the power used for lighting, requiring greater amounts than what is strictly necessary.

This is because the light is projected from a considerable height, which means that it must cross a long distance in the air, which diffuses the light.

The light also hits the ground at a considerable angle, which makes it reflect towards the zenith, with the corresponding contribution to light pollution and the wasting of energy.

On the other hand, there are also beacon pylons and protection aimed at the demarcation of spaces intended for circulation and at providing a physical barrier to protect these spaces from the invasion of vehicles circulating on the road.

For this reason, it is evident that there is a need for an element that can deal with the drawbacks mentioned, that is to say, to appropriately mark and set off the pedestrian crossing and similar crossings, providing efficient and optimal lighting, and reducing the number of urban furnishing elements.

### SUMMARY OF THE INVENTION

With the device for the lighting and/or demarcation of pedestrian crossings that is the object of the invention, the aforementioned drawbacks are solved, as well as having other advantages that will be described below.

The arrangement of the demarcation for pedestrian crossings of the invented device consists of a series of advertising posts or columns placed on at least one corner at each end of the pedestrian crossing, marking the boundaries of the crossing itself.

According to the invention, the columns can be connected to any electrical power infrastructure, etc., or they can provide their own energy by solar, wind power means, and like.

These posts or columns are made up on their exterior surface of one or more solar panels connected to an electric power accumulator placed on the inside of the post.

This allows an autonomous, renewable source of energy to power the lamps of the device, making it suitable for sidewalks or streets planned for the future, as well as those already in existence.

Advantageously, the device of the invention comprises means for closing the circuit when the solar panel provides a current of less than a certain first threshold, and for opening the circuit when the solar panel supplies a current greater than a certain second threshold.

These features guarantee that energy will only be supplied to lamps with low levels of surrounding lighting, namely when it is necessary, the solar panel serving two functions, acting as a source of energy and a lighting sensor. In addition, as two thresholds are established, the stability of the system for opening and closing the circuit is maintained.

The feeding of electricity will allow the column to be lit, clearly signalling its location and the demarcation of the pedestrian crossing during the night. It can also produce sounds, flashes, etc. in order to facilitate the crossing of handicapped pedestrians.

The arrangement of the lighting of pedestrian crossings of the device invented is made up of a plurality of posts or columns, each provided of a lamp, and it is characterised by the fact that these lamps are placed mainly in the lower part of the posts, and by the fact that its light is distributed over the surface of the pedestrian crossing.

With this arrangement, lighting is provided guaranteeing a great deal of homogeneity, while lighting only the areas desired. In addition, as they are located on the low part and they reflect on the bands of the pedestrian crossing, a minimum of lighting energy is required and light pollution is minimised.

Preferably, the posts or columns have housings for signs on their side surfaces, so that the device invented can be used as a support for information, such as for instance road information or advertisements.

More preferably, said housings have a plurality of lamps placed between the aforementioned signs and the back wall of the housing, this back wall being covered with a reflective layer.

This creates a lit system of demarcation and support of information, which allows it to be operational 24 hours a day.

Advantageously, the lamps arranged between the signs and the back wall of the housing are connected parallel to the lamp placed on the low part, in such a manner that the control system is also taken advantage of for lighting the signs.

More advantageously, these lamps have a plurality of diode light sources or energy-saving lights.

In this manner, the device uses a long-lasting, energy-saving light source, which allows the device to optimise energy use and decrease maintenance costs.

Preferably, the lamps are placed in a housing whose opening delimits the projection of the light cone onto the surface of the pedestrian crossing, so that the light is projected where necessary, which is on the pedestrian crossing.

Advantageously, the aforementioned posts or columns include anchoring means to the ground to facilitate installation, so that the device can be supplied with all of the necessary functions, including the anchoring. This anchoring may be adapted to roads and sidewalks, so that it may also serve as physical protection for pedestrians, or to mark off parking areas to avoid improper parking.

The posts or columns preferably have a rectangular base on the surface of which there is a solar panel, which allows the prefabrication of the posts with a rectangular block that may directly be fit in and attached to the ground after a rectangular hollowing of the ground, and taking advantage of the manufacturing process to place a solar panel on the top surface of said block.

The posts preferably include an opening substantially on the high part of one or more side surfaces, giving access to an ashtray, which gives the device the additional function of an ashtray, especially useful at a place where people wait, such as the edges of a pedestrian crossing.

These and other characteristics will be best made apparent by the following detailed description whose understanding will be made easier by the accompanying three sheets of drawings showing a practical embodiment being cited only by way of an example not limiting the scope of the present invention.

### DESCRIPTION OF THE DRAWINGS

FIG. 1 is a perspective view of the device object of the invention according to a preferred embodiment.

FIG. 2 is a simplified diagram of the internal circuit of the device object of the invention.

FIG. 3 is a perspective view of a post or column according to the invention.

FIG. 4 illustrates a perspective view of a pedestrian crossing marked off by four advertising columns or posts according to the present invention, which are placed on the four corners of the pedestrian crossing.

FIG. 5 illustrates a perspective view similar to FIG. 4, where the pedestrian crossing is marked off by only two advertising columns or posts of the invention, which are placed diagonally and on two opposite corners of the pedestrian crossing.

FIG. 6 illustrates a perspective view similar to FIGS. 4 and 5, where the pedestrian crossing or similar is marked off by four advertising columns or similar posts that are placed on the four corners of the pedestrian crossing and positioned on the road.

FIG. 7 illustrates the four examples of advertising columns or posts of the invention of FIGS. 4, 5, and 6.

### DETAILED DESCRIPTION OF ONE FORM OF PREFERRED EMBODIMENT

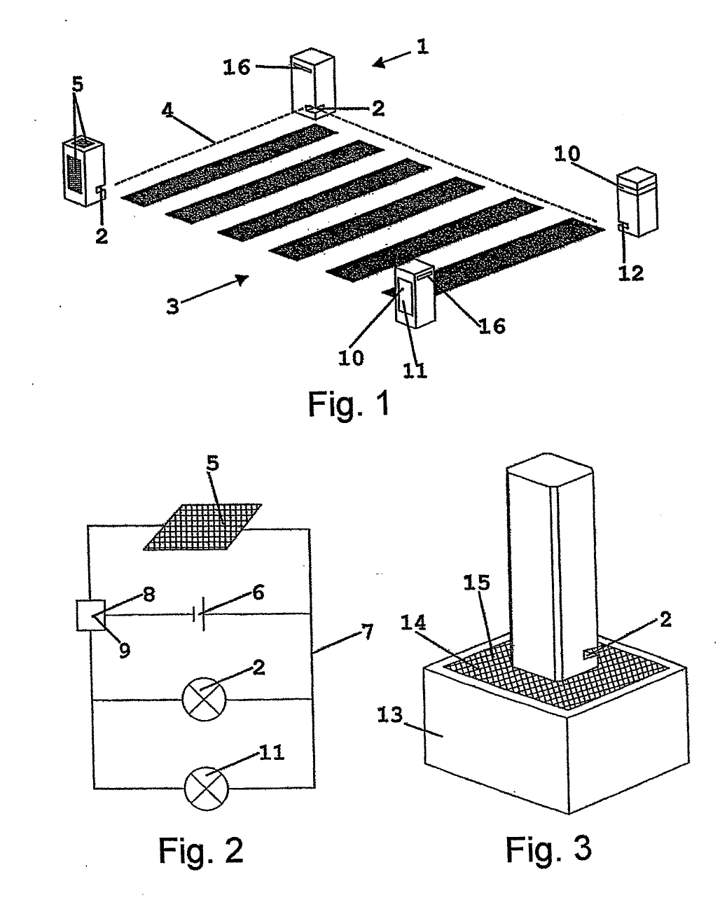

According to the drawings, FIG. 1 illustrates the lighting of pedestrian crossings of the invented device, comprising various posts or columns, (1) each having a lamp (2) and placed on corners of the pedestrian crossing (3), the lamps (2) being placed on the low part of the aforementioned posts, so that its light (4) is projected and spread out over the surface of the pedestrian crossing, as its opening (12) is intended to mark off the light cone.

The presence of several posts or columns, the orientation of the light cone from a point close to the ground that hits the ground essentially tangentially, and the presence of white paint on the pedestrian crossing, makes the lighting optimal for users with minimum energy cost and lighting pollution.

FIG. 2 illustrates the power supply to the lamps (2) and (11), which may come from any electrical grid infrastructure, or from a battery or electrical accumulator (6) that will be recharged by one or more solar panels (5) placed on the exterior surface of the posts or columns (1).

More specifically, the panels (5) can be placed on the upper surface or on the sides, according to their orientation.

For the purpose of optimising the lighting system from an energy point of view, the system includes means (8) of closing the circuit (7) that connects the battery (6) to the lamp (2) when the panel provides less current than a first predetermined threshold, the panel acting as a light sensor.

Also, to give stability to the system, so that it doesn't turn off and on because of quick variations in the level of lighting, for instance due to the passing of vehicles, clouds that temporarily cover the sun, or other causes, the mechanism (8) will include means for opening the circuit (7) when the solar panel (5) supplies a current greater than a second predetermined threshold, greater than the first.

The posts or columns of the arrangement of the lighting may extend their functions, as they include means of support for visual information, such as for instance road information or advertising. These means allow advertising to be placed vertically on one of the faces or as a strip around the upper part. This information may be backlit, or it may consist of openings in the form of letters that let the light go through a lamp with means for diffusing the light (11), placed on the inside.

It is foreseen that these backlighting lamps (11) are energy saving and supplied with power by the same battery (6) as the lamps (2) for lighting the pedestrian crossing.

The posts or columns may be supplied with a system to anchor them to the ground, which may be expanding wall plugs, anchoring rods, anchoring nails, or similar. This anchoring system may be adapted to either the road or the sidewalk.

FIG. 3 illustrates the posts or columns with a rectangular block (13), the base of which may be made of tiles, or this surface may be taken advantage of for placing a solar panel (14) there, covered with a transparent surface where circulation is possible (15). In this case, the installation is simpler, as whole tiles have to be taken out and a rectangular block dug.

Additionally, the posts or columns include openings (16) on the upper parts of its outside surfaces, which provide access to ashtrays, thus contributing to the cleaning of the pavement.

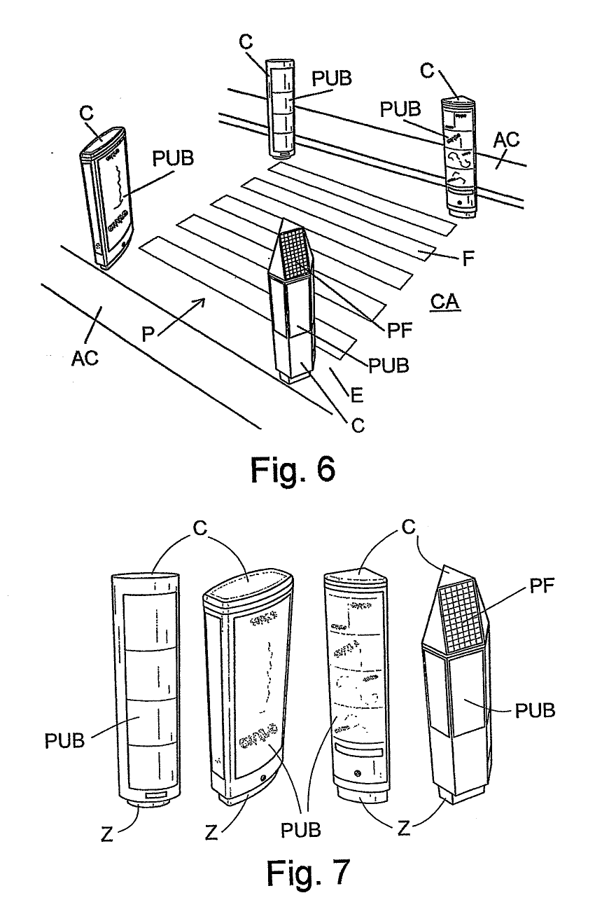

On the other hand, the arrangement of the demarcation of the pedestrian crossings of the device invented, illustrated in FIGS. 4 to 7, where the advertising column or post -C- of the arrangement of the demarcation of the pedestrian crossing -P- and similar, of the presently invented device, in which the pedestrian crossings are normally defined by a series of strips -F- drawn on the road -CA-, whose strips -F- are parallel to each other and in general to the geometrical main axis of the road, or based on a pair of strips that define the crossing and that are perpendicular to the aforementioned axis of the road -CA- these last not being illustrated.

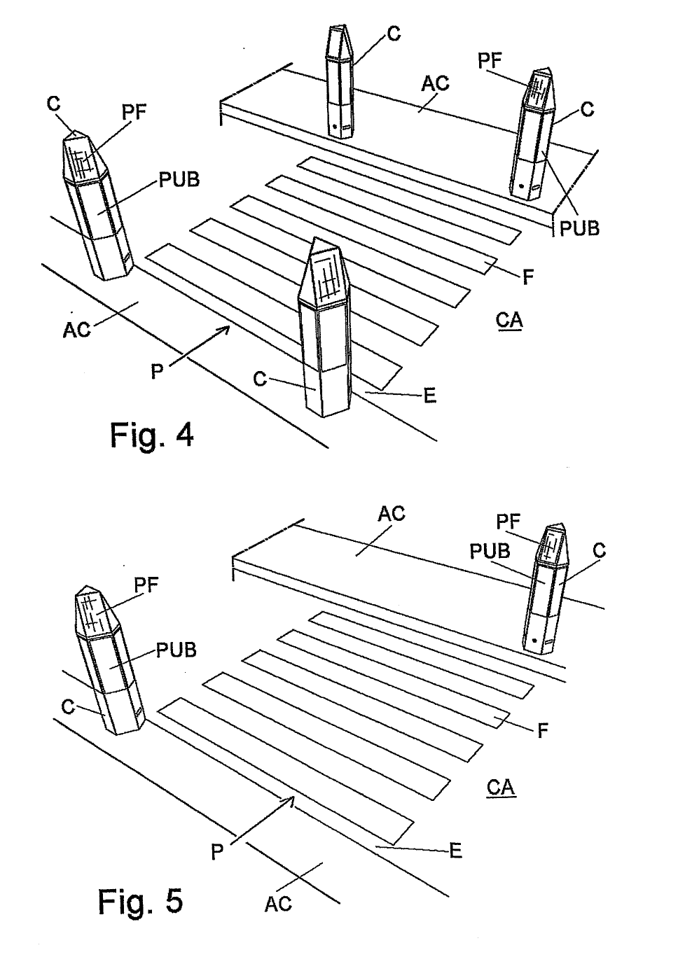

According to the drawings, the arrangement of the demarcation of pedestrian crossings -P- of the device of the invention using posts attached to the ground on the corners -E- of the pedestrian crossing -P- and similar, consist of a series of advertising columns, with the general reference C, which are placed on a corner (FIG. 5) or on both corners -E- (FIG. 4) of the pedestrian crossing -P-, at each end of the pedestrian crossing, in such a manner that the aforementioned advertising columns or posts -C- mark the “crossing” or “pass” -P- lengthened like a rectangle for the pedestrian crossing, crosswalk, or special crossing for bicycles, horses, special vehicles, etc.

The “crossings” or “passes” defined in FIGS. 4 and 5 are only differentiated, as has been indicated, in that in FIG. 4 the “crossing,” “pass” or “corridor” -P- is marked off by a pair of advertising columns or posts -C- placed on each corner at each end, whereas in FIG. 5 the aforementioned “crossing,” “pass,” or “corridor” is only marked off by two advertising columns or posts -C- placed diagonally on the opposite end corners of the pedestrian crossing -P-, serving the same purpose. Although it is not illustrated, there is also the possibility of placing the two columns or posts -C- parallel to each other on two opposite corners of the pedestrian crossing -P-.

Of course, the arrangement that places the advertising column or post outside -C- may be however it is convenient, as it does not change the essential nature of the invention.

In all cases, the column or post -C- presents the advertising -PUB- in a visible area, especially although not exclusively for pedestrians, whether on bicycle, in a vehicle, on foot, running, on horseback, etc.

As is illustrated in the drawings, the advertising column or post -C- of the device that is the object of the present invention, may be connected to any electrical facility or service, and at the same time it may have means to produce electricity by any suitable alternative means, such as solar panels with their corresponding solar panels -PF-, or by wind power (not illustrated) with blades for the wind, or any other means of producing its own power. In this last case, this would eliminate the need to hook the advertising columns -C- to the electrical grid, which would mean that the invention could be placed wherever convenient, whether or not there are infrastructures (electrical grid, etc.).

Thus, the aforementioned electric power allows the advertising column or post -C- to light up the advertising -PUB- of the column itself and produce sounds, flashes, and other elements to allow handicapped pedestrians to pass.

The advertising columns -C- preferably have a baseboard -Z- to improve their anchoring to the ground and to protect them by separating them a certain distance from the ground.

Additionally, the advertising columns are placed, preferably on sidewalks -AC- (see FIGS. 1 and 2) or directly on the road -CA- (FIG. 3), preventing vehicles from parking on the pedestrian crossing.

Of course, the advertising column -C- of the device of the present invention foresees the possibility of including additional and complementary accessories for pedestrians, such as, for instance, maps of the area, and of nearby public and private transportation.

The advertising column -C- in question is made with the most suitable materials for its public, outdoor function.

The device for the lighting and/or demarcation of pedestrian crossings, the object of the present invention, in essence may be carried out in practice in other forms of arrangement that differ only in the details indicated as examples, which will also share in the protection obtained.

1. A device for lighting and/or demarcation of pedestrian crossings, comprising a plurality of posts or columns attached to the ground on the corners of the pedestrian crossing, wherein the demarcation posts or columns, are placed on at least one corner at each end of the pedestrian crossing, and wherein the posts or columns are provided with lighting lamps placed mainly in the lower part of said posts or columns, the light of which is distributed over the surface of the pedestrian crossing.

2. A device for lighting and/or demarcation of pedestrian crossings, according to claim 1, wherein said posts or columns have housings for signs on their side surfaces.

3. A device for lighting and/or demarcation of pedestrian crossings, according to claim 1, wherein said housings have a plurality of lamps placed between the signs and the back wall of the housing, the back wall being covered with a reflective layer.

4. A device for lighting and/or demarcation of pedestrian crossings, according to claim 1, wherein said lamps arranged between the signs and the back wall of the housing are connected parallel to said lamp placed on the lower part.

5. A device for lighting and/or demarcation of pedestrian crossings, according to claim 1, wherein said lamps have a plurality of diode light sources or energy-saving lights.

6. A device for lighting and/or demarcation of pedestrian crossings, according to claim 1, wherein said posts or columns comprise on their exterior surface one or more solar panels connected to an electric power accumulator placed on the inside of the post, said accumulator being connected to said lamp by a circuit.

7. A device for lighting and/or demarcation of pedestrian crossings, according to claim 1, comprising means for closing said circuit when the solar panel provides a current of less than a certain first threshold.

8. A device for lighting and/or demarcation of pedestrian crossings, according to claim 1, comprising means for opening said circuit when the solar panel supplies a current greater than a certain second threshold.

9. A device for lighting and/or demarcation of pedestrian crossings, according to claim 1, wherein said lamps are placed in a housing having an opening delimiting the projection of the light cone onto the surface of the pedestrian crossing.

10. A device for lighting and/or demarcation of pedestrian crossings, according to claim 1, wherein said posts or columns comprise anchoring means to the ground.

11. A device for lighting and/or demarcation of pedestrian crossings, according to claim 1, wherein said posts or columns have a rectangular base on the surface of which is a solar panel.

12. A device for lighting and/or demarcation of pedestrian crossings, according to claim 1, comprising an opening substantially provided on the high part of one or more side surfaces, giving access to an ashtray.

13. A device for lighting and/or demarcation of pedestrian crossings, according to claim 1, wherein the advertising columns or posts are connected to an electrical power infrastructure, or provide their own energy by solar wind power means, and the like.

14. A device for lighting and/or demarcation of pedestrian crossings, according to claim 1, wherein the electric power provides for lighting the advertising and lamps of the advertising posts or columns and producing sounds, flashes, etc. to allow handicapped pedestrians to pass.
